(19) United States
(12) Patent Application Publication
(10) Pub. No.: US 2016/0261429 A1
(43) Pub. Date: Sep. 8, 2016

(54) PROTECTION TUNNEL

(71) Applicant: HANGZHOU H3C TECHNOLOGIES CO., LTD., Zhejiang (CN)

(72) Inventors: Zhonghua GAO, Beijing (CN); Jianfeng LIU, Beijing (CN); Kai ZHONG, Beijing (CN); Zhenhua GUO, Beijing (CN)

(73) Assignee: Hangzhou H3C Technologies Co., Ltd., Hangzhou City (CN)

(21) Appl. No.: 15/029,453

(22) PCT Filed: Oct. 27, 2014
(86) PCT No.: PCT/CN2014/089560

§ 371 Date: Apr. 14, 2016

(30) Foreign Application Priority Data
Oct. 25, 2013 (CN) 201310511577.4

(51) Int. Cl. H04L 12/46; H04L 12/913; H04L 12/703; H04L 12/42

(52) U.S. Cl. CPC H04L 12/4633; H04L 12/42; H04L 47/724; H04L 45/28; H04L 2012/421

(57) ABSTRACT

A network device configures a unique ring number for each interface in a ring network and stores the ring number. The network device receives a RSVP confirmation packet from a next-hop network device, storing a route object record contained in the RSVP confirmation packet. The network device parses the route object record of the primary tunnel, searches for an end network device on the primary tunnel in the same ring network, sets the end network device as a destination network device of a protection tunnel of the network device, sets the network device as a start network device of the protection tunnel, and store path information of the protection tunnel. An interface of the end network device has the same ring number with an egress interface of the network device.

### BACKGROUND

Constraint-based Routed Label Switched Paths (CRLSP) that is established dynamically based on Resource Reservation Protocol (RSVP) may perform network protection of a dynamical CRLSP through Traffic Engineering Auto Fast ReRoute (TE Auto FRR) technology. The TE FRR technology includes a link protection technology and a node protection technology.

The TE Auto FRR technology can only establish a link protection tunnel or a node protection tunnel dynamically, and thus the TE Auto FRR technology cannot perform the network protection of the dynamical CRLSP when multiple nodes on a working CRLSP are failed.

### BRIEF DESCRIPTION OF THE DRAWINGS

Features of the present disclosure are illustrated by way of example and not limited in the following figure(s), in which like numerals indicate like elements, in which:

FIG. 1 is a flowchart illustrating a method for establishing a protection tunnel for replacing a primary tunnel when multiple nodes on the primary tunnel are failed according to an example of the present disclosure.

FIG. 2 is a diagram illustrating RSVP ring numbers configured for interfaces of intersection networks according to an example of the present disclosure.

FIG. 3 is a diagram illustrating the structure of an extended ring number subobject according to an example of the present disclosure.

FIG. 4 is a diagram illustrating the structure of a route object record in RSVP signaling according to an example of the present disclosure.

FIG. 5 is a flowchart illustrating a method for establishing a protection tunnel for replacing a primary tunnel when multiple nodes on the primary tunnel are failed according to another example of the present disclosure.

FIG. 6 is a flowchart illustrating a method for sending a data packet via a protection tunnel when a primary tunnel is failed according to an example of the present disclosure.

FIG. 7 is a diagram illustrating the structure of a network device according to an example of the present disclosure.

FIG. 8 is a diagram illustrating the structure of a network device according to another example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. Throughout the present disclosure, the terms “a” and “an” are intended to denote at least one of a particular element. As used herein, the term “includes” means includes but not limited to, the term “including” means including but not limited to. The term “based on” means based at least in part on.

At present, the TE Auto FRR technology may perform network protection of a CRLSP established based on the RSVP when the CRLSP traverses a network.

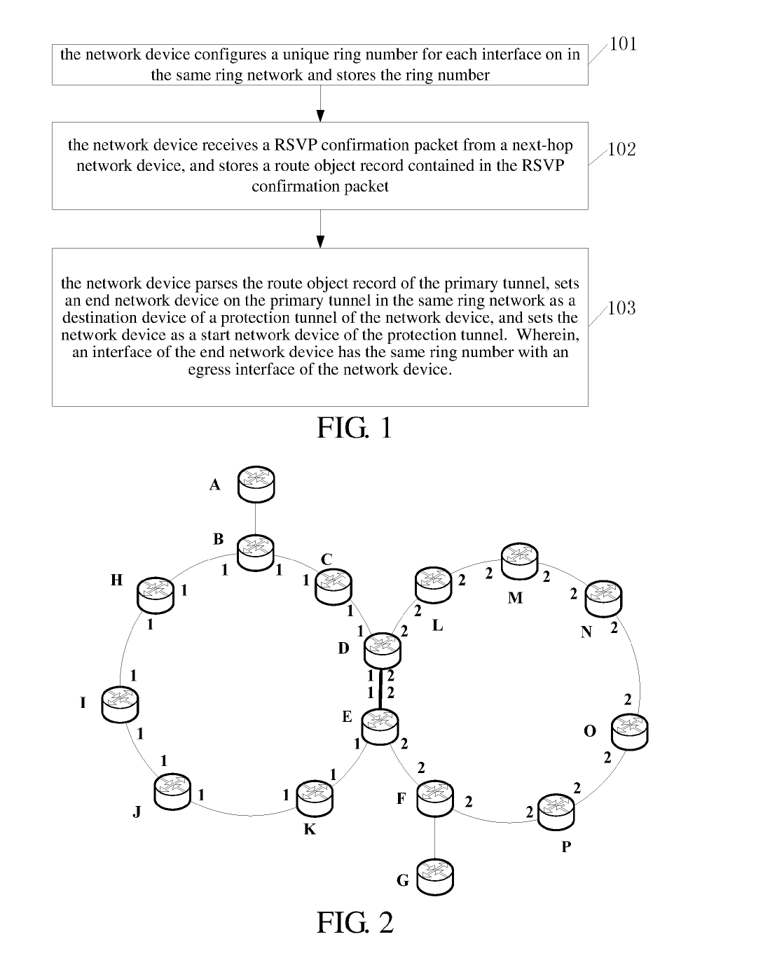

FIG. 1 is a flowchart illustrating a method for establishing a protection tunnel for replacing a primary tunnel when multiple nodes on the primary tunnel are failed according to an example of the present disclosure. The method may be applied to a network device in a ring network. The network device adopts the TE Auto FRR technology, and interfaces of the network device run the RSVP. The method includes following blocks.

At block 101, the network device configures a unique ring number for each interface in the same ring network and stores the ring number.

The ring number may identify the ring network, and interfaces of all network devices in the same ring network have the same ring number.

At block 102, the network device receives a RSVP confirmation packet from a next-hop network device, and stores a route object record contained in the RSVP confirmation packet. The route object record contained in the RSVP confirmation packet records ring numbers of ingress interfaces and egress interfaces of all network devices on the primary tunnel. Further, the network device may forward the RSVP confirmation packet to a last-hop network device.

At block 103, the network device parses the route object record of the primary tunnel, sets an end network device on the primary tunnel in the same ring network as a destination device of a protection tunnel of the network device, and sets the network device as a start network device of the protection tunnel. Wherein, an interface of the end network device has the same ring number with an egress interface of the network device. The start network device, the destination network device and network devices between the start network device and the destination network device constitute the protection tunnel of the network device, and path information of the protection tunnel is stored.

In the network device, each interface running the RSVP is configured with a ring number. The ring number is assigned by a network manager, and interfaces of all network devices in a ring network are configured with the same ring number. When an interface belongs to multiple ring networks, the interface may be configured with multiple ring numbers. As shown in FIG. 2, devices B, C, D, E, H, I, J and K belong to the same ring network, and the ring number of each interface of the above devices is configured with 1. Devices D, E, F, L, M, N, O and P belong to the same ring network, and the ring number of each interface of the above devices is configured with 2. Interfaces corresponding to a link between the device D and the device E belong to two ring networks, and thus are configured with two ring numbers 1 and 2. In each network device, an interface for receiving a packet is defined as an ingress interface and an interface for sending a packet is defined as an egress interface.

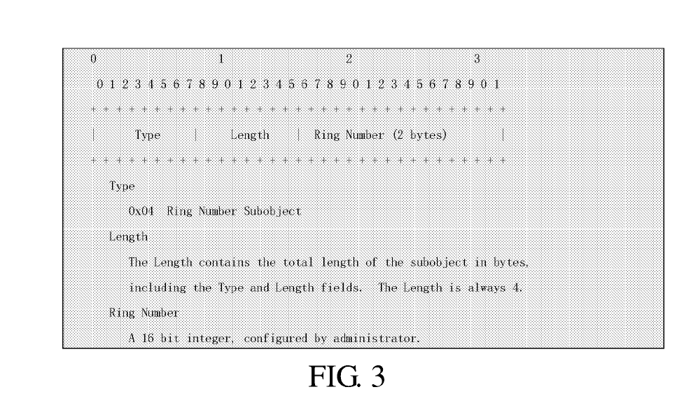

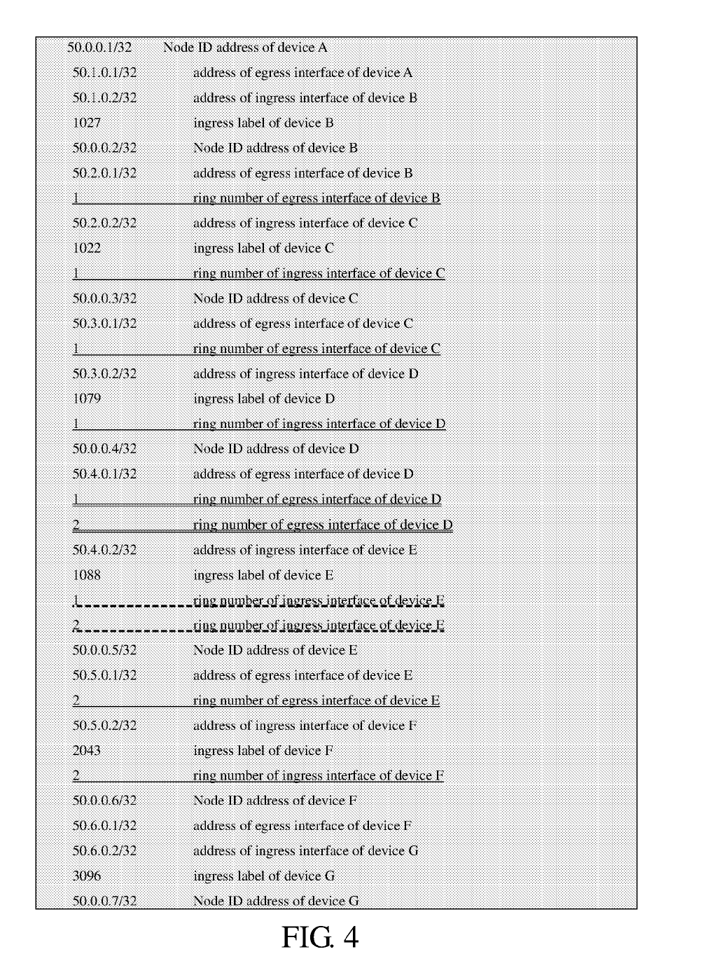

In the example of the present disclosure, the route object record in the RSVP signaling is extended, and a Ring Number Subobject for recording ring numbers of an ingress interface and an egress interface is added to the route object record, as shown in FIG. 3. When an interface belongs to multiple ring networks, multiple Ring Number Subobjects may be added. FIG. 4 shows an address list of a route object record of a primary tunnel from the device A to the device G shown in FIG. 2. In FIG. 4, ring numbers with underlines are newly added Ring Number Subobjects. Through the route object record, each network device may learn that a CRLSP enters the ring network at which node, and leaves the ring network at which node. For example, the route object record in FIG. 4 denotes that the CRLSP enters a ring network at the device B, leaves the ring network at the device E, enters another ring network at the device D and leaves the ring network at the device F.

When a backup tunnel is generated through the conventional TE Auto FRR technology, a destination device of a node protection tunnel is usually a next-next-hop node of a source device. The destination device is a merge point of the backup tunnel and the primary tunnel, that is, a tail node of the backup tunnel. For example, in a conventional technology, the destination device of the protection tunnel of the device B shown in FIG. 2 is the device D. However, in an example of the present disclosure, when the device B finds that it is in a ring network, the device B may select the last network device on the primary tunnel in the same ring network as the destination device of the protection tunnel. The destination device of the protection tunnel may be obtained through parsing the route object record of the primary tunnel, that is, the destination device of the protection tunnel is the device E. Accordingly, even if the device C and the device D on the primary tunnel are failed at the same time, the traffic of the working CRLSP may arrive at the device E across the failed devices. It is impossible that the working CRLSP is disconnected because the protection tunnel is failed, so that the TE Auto FRR technology can implement protection functions.

In an example, a switch is used as a network device. Suppose a protocol packet is sent to a switch G by a switch A via two ring networks, as shown in FIG. 2. Switches on the primary tunnel in the ring networks include switches B, C, D, E and F. Accordingly, the working CRLSP enters a left ring network through the switch B, leaves the left ring network from the switch E, enters a right ring network through the switch D, and leaves the right ring network from the switch F. Ring numbers of interfaces of the switches in the left ring network are configured with 1, and ring numbers of interfaces of the switches in the right ring network are configured with 2. The switch D and the switch E belong to the two ring networks at the same time, and interfaces corresponding to a link between the switch D and the switch E are configured with two ring numbers 1 and 2.

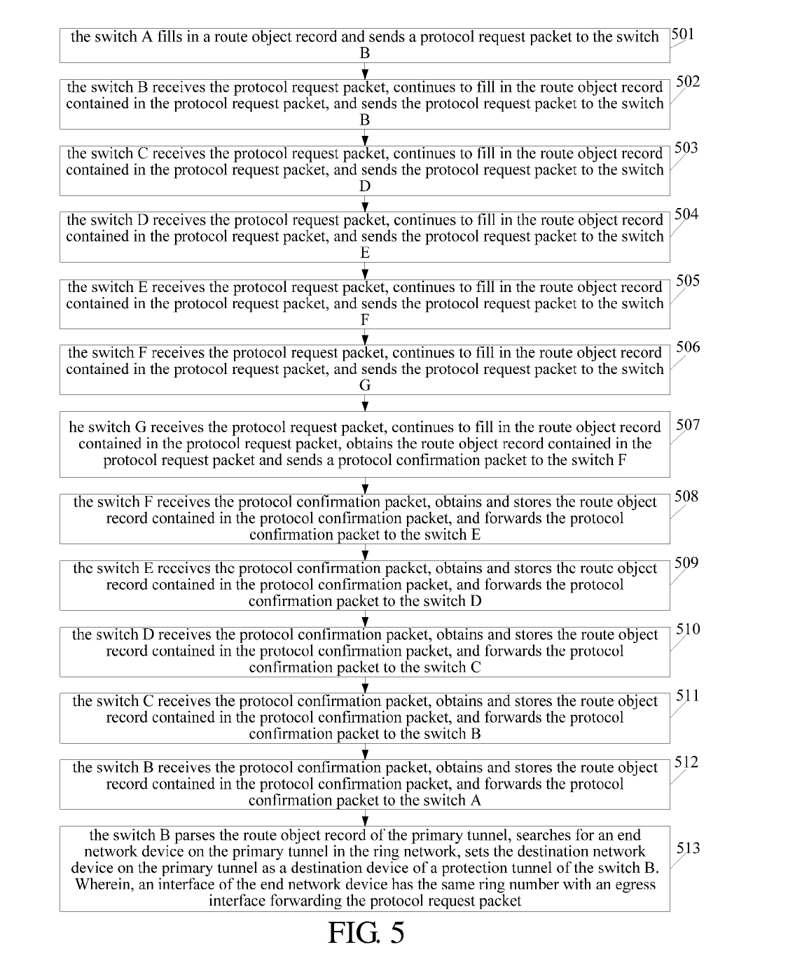

FIG. 5 is a flowchart illustrating a method for establishing a protection tunnel for replacing a primary tunnel when multiple nodes on the primary tunnel are failed according to another example of the present disclosure. In the example, suppose the switch B on the primary tunnel is to establish a protection tunnel. As shown in FIG. 5, the method includes following blocks.

At block 501, the switch A fills in a route object record and sends a protocol request packet to the switch B.

At this block, the switch A fills in the route object record contained in the protocol request packet with the node ID address of the switch A and the address information of an egress interface of the protocol request packet, and sends the protocol request packet to the switch B via the egress interface of the switch A.

At block 502, the switch B receives the protocol request packet, continues to fill in the route object record contained in the protocol request packet, and sends the protocol request packet to the switch B.

In this block, the switch B fills in the route object record contained in the protocol request packet with the address of an ingress interface of the protocol request packet, an ingress label, the node ID address of the switch B, the address of an egress interface for forwarding the protocol request packet by the switch B, and the ring number information of the egress interface. The egress interface of the switch B is located in the ring network, and has a ring number 1. The ring number information of the egress interface is filled in the route object record, so that a switch in the ring network conveniently searches for the last network device on the primary tunnel in the ring network when establishing a protection tunnel, and selects the last network device on the primary tunnel as a destination network device of the protection tunnel. Afterwards, the switch B forwards the protocol request packet to the switch C via the egress interface. The egress interface is an egress interface filled in the route object record by the switch B.

At block 503, the switch C receives the protocol request packet, continues to fill in the route object record contained in the protocol request packet, and sends the protocol request packet to the switch D.

In this block, the switch C fills in the route object record contained in the protocol request packet with the address of an ingress interface of the protocol request packet, an ingress label, the ring number of the ingress interface, the node ID address of the switch C, the address of an egress interface for forwarding the protocol request packet by the switch C, and the ring number information of the egress interface. The ingress interface and the egress interface of the switch C are located in the ring network, and have a ring number 1 respectively. The ring number information of the ingress interface and the egress interface are filled in the route object record, so that a switch in the ring network conveniently searches for the last network device on the primary tunnel in the ring network when establishing a protection tunnel, and selects the last network device on the primary tunnel as a destination network device of the protection tunnel. Afterwards, the switch C forwards the protocol request packet to the switch D via the egress interface. The egress interface is an egress interface filled in the route object record by the switch C.

At block 504, the switch D receives the protocol request packet, continues to fill in the route object record contained in the protocol request packet, and sends the protocol request packet to the switch E.

In this block, the switch D fills in the route object record contained in the protocol request packet with the address of an ingress interface of the protocol request packet, an ingress label, the ring number of the ingress interface, the node ID address of the switch D, the address of an egress interface for forwarding the protocol request packet by the switch D, and the ring number information of the egress interface. The ingress interface and the egress interface of the switch D are located in the ring network, and have a ring number 1 respectively. The egress interface of the switch D is located on two ring networks, and thus has ring numbers 1 and 2. Accordingly, the switch D needs to record the ring number information of the egress interface including the ring number 1 and the ring number 2, which are marked with double real underlines in FIG. 4. The ring number information of the ingress interface and the egress interface are filled in the route object record, so that a switch in the ring network conveniently searches for the last network device on the primary tunnel in the ring network when establishing a protection tunnel, and selects the last network device on the primary tunnel as a destination network device of the protection tunnel. Afterwards, the switch D forwards the protocol request packet to the switch E via the egress interface. The egress interface is an egress interface filled in the route object record by the switch D.

At block 505, the switch E receives the protocol request packet, continues to fill in the route object record contained in the protocol request packet, and sends the protocol request packet to the switch F.

In this block, the switch E fills in the route object record contained in the protocol request packet with the address of an ingress interface of the protocol request packet, an ingress label, the ring number of the ingress interface, the node ID address of the switch E, the address of an egress interface for forwarding the protocol request packet by the switch E, and the ring number information of the egress interface. The ingress interface and the egress interface of the switch E are located in the ring network. The ingress interface is located on two ring networks, and thus has ring numbers 1 and 2. The ring number of the egress interface is 2. Accordingly, the switch E needs to record the ring number information of the ingress interface including the ring number 1 and the ring number 2, which are marked with dashed underlines in FIG. 4. The ring number information of the ingress interface and the egress interface are filled in the route object record, so that a switch in the ring network conveniently searches for the last network device on the primary tunnel in the ring network when establishing a protection tunnel, and selects the last network device on the primary tunnel as a destination network device of the protection tunnel. Afterwards, the switch E forwards the protocol request packet to the switch F via the egress interface. The egress interface is an egress interface filled in the route object record by the switch E.

At block 506, the switch F receives the protocol request packet, continues to fill in the route object record contained in the protocol request packet, and sends the protocol request packet to the switch G.

In this block, the switch F fills in the route object record contained in the protocol request packet with the address of an ingress interface of the protocol request packet, an ingress label, the ring number of the ingress interface, the node ID address of the switch F, and the address of an egress interface for forwarding the protocol request packet by the switch F. The ingress interface of the switch F is located in the ring network, and has a ring number 2. The egress interface of the switch F is not located in the ring network, and thus has no ring number. Accordingly, the switch F records the ring number of the ingress interface as 1. The ring number information of the ingress interface is filled in the route object record, so that a switch in the ring network conveniently searches for the last network device on the primary tunnel in the ring network when establishing a protection tunnel, and selects the last network device on the primary tunnel as a destination network device of the protection tunnel. Afterwards, the switch F forwards the protocol request packet to the switch G via the egress interface. The egress interface is an egress interface filled in the route object record by the switch F.

At block 507, the switch G receives the protocol request packet, continues to fill in the route object record contained in the protocol request packet, obtains the route object record contained in the protocol request packet and sends a protocol confirmation packet to the switch F.

In this block, the switch G fills in the route object record contained in the protocol request packet with the address of an egress interface of the protocol request packet, an ingress label, and the node ID address of the switch G. Afterwards, the switch G obtains an address list recorded in the route object record contained in the protocol request packet, fills the address list in a route object record contained in the protocol confirmation packet, and sends the protocol confirmation packet to the switch F.

At block 508, the switch F receives the protocol confirmation packet, obtains and stores the route object record contained in the protocol confirmation packet, and forwards the protocol confirmation packet to the switch E.

In this block, the switch F receives the protocol confirmation packet, obtains and stores the route object record contained in the protocol confirmation packet. The route object record records information of all switches on the primary tunnel, including addresses of ingress interfaces and egress interfaces of the switches, ring numbers of ingress interfaces and egress interfaces of the switches, ingress labels and node ID addresses of the switches. Afterwards, the switch F forwards the protocol confirmation packet to the switch E.

At blocks 509 to 512, the switches E, D, C and B perform the processing performed by the switch F at block 508, obtain and store the route object record contained in the protocol confirmation packet, and forward the protocol confirmation packet to the last-hop switch on the primary tunnel.

At block 513, the switch B parses the route object record of the primary tunnel, searches for an end network device on the primary tunnel in the ring network, sets the destination network device on the primary tunnel as a destination device of a protection tunnel of the switch B. Wherein, an interface of the end network device has the same ring number with an egress interface forwarding the protocol request packet.

In this block, the switch B parses the stored route object record of the primary tunnel. The route object record contains ring numbers of an ingress interface and an egress interface of each network device on the primary tunnel. The ring number of the egress interface for forwarding the protocol request packet by the switch B is 1. The switch B searches the route object record of the protocol request packet for an end network device on the primary tunnel in the ring network, wherein the ring number of the egress interface of the end network device is 1. In the route object record shown in FIG. 4, the end network device on the primary tunnel in the ring network is the switch E, wherein the ring number of the egress interface of the end network device is 1. The switch B sets the switch E as a destination device of the protection tunnel. A path of the protection tunnel of the switch B is B-H-I-J-K-E. When a single node or multiple nodes are failed in a link between the switch B and the switch E on the working CRLSP of the primary tunnel, the switch B may forward data packets to the switch E via the protection tunnel, and further the data packets are sent to the switch G.

In an example, through configuring a ring number for an interface of a network device and extending the route object record, the route object record may contain the ring number of the interfaces of the network device through which the working CRLSP passes. In this way, the network device can learn that the working CRLSP enters the ring network at which node, and leaves the ring network at which node, and further sets the node at which the working CRLSP leaves the ring network as the destination node of the protection tunnel of each network device in the ring network, so that traffic may be successfully forwarded through the protection tunnel when multiple nodes on the primary tunnel are failed.

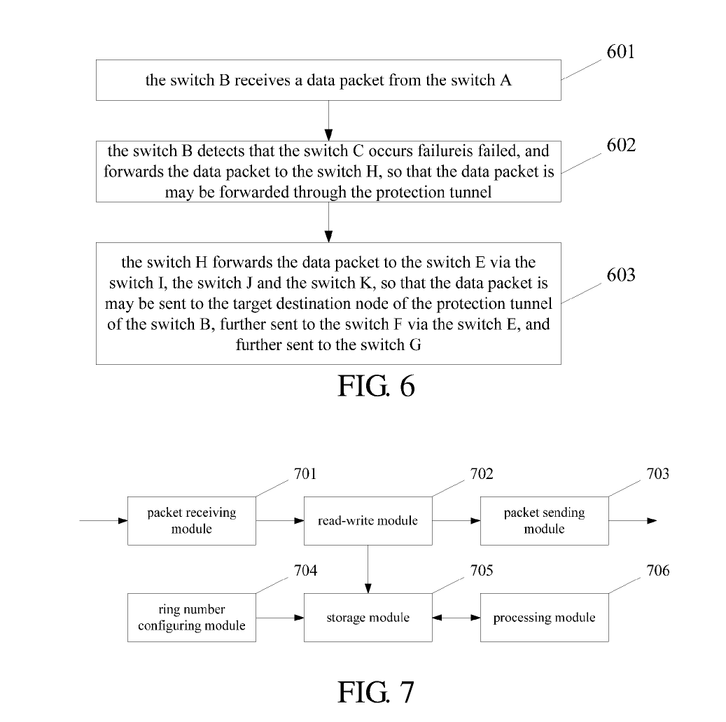

In this example, suppose each switch on the primary tunnel shown in FIG. 2 has established its protection tunnel. When a data packet is forwarded, suppose the switch C and the switch D on the primary tunnel are failed at the same time, the solution of the present disclosure is described herein. FIG. 6 is a flowchart illustrating a method for sending a data packet through a protection tunnel when a primary tunnel is failed according to an example of the present disclosure. As shown in FIG. 6, the method includes following blocks.

At block 601, the switch B receives a data packet from the switch A.

At block 602, the switch B detects that the switch C is failed, and forwards the data packet to the switch H, so that the data packet may be forwarded through the protection tunnel.

In this block, when the switch C is failed, the path of the primary tunnel from the switch B to the switch C and further to the switch G is failed. The switch B detects this failure, and forwards the data packet to the switch H, so that the data packet may be forwarded through the protection tunnel.

Block 603, the switch H forwards the data packet to the switch E via the switch I, the switch J and the switch K, so that the data packet may be sent to the destination node of the protection tunnel of the switch B, further sent to the switch F via the switch E, and further sent to the switch G.

In this block, the data packet is forwarded via the protection tunnel of the switch B, and arrives at the destination node of the protection tunnel of the switch B via a path of H-I-J-K-E. Afterwards, the switch E sends the data packet to the switch F, and further sends the data packet to the switch G.

Since the switch D is also failed, if the destination node of the protection tunnel is set as the next-next-hop node of the switch B, that is, the switch D, the protection tunnel may also be failed, so as to cause the disconnection of the working CRLSP. In an example, the destination node of the protection tunnel may be set as the switch E at which the primary tunnel leaves the ring network. When multiple nodes on the primary tunnel in the ring network are failed, the data packet may still be forwarded via the protection tunnel, so as to avoid the disconnection of the working CRLSP.

An example of the present disclosure provides a network device, as shown in FIG. 7. The network device includes following modules. The modules may for example be implemented by a hardware processor or plurality of hardware processors such as an application specific integrated chip (ASIC), or a field programmable gate array (FPGA), or by a hardware processor executing machine instructions stored on a non-transitory storage medium, or a combination thereof.

A packet receiving module 701 may receive a protocol confirmation packet from the next-hop network device.

A read-write module 702 may obtain a route object record contained in the protocol confirmation packet, and the route object record contained in the protocol confirmation packet records ring numbers of ingress interfaces and egress interfaces of all network devices on a primary tunnel.

A packet sending module 703 may forward the protocol confirmation packet to the last-hop network device of the network device.

A ring number configuring module 704 may configure a ring number for each interface, wherein the ring number may identify a ring network, and interfaces of all network devices belonging to the same ring network have the same ring number.

A storage module 705 may store ring numbers, the route object record contained in the protocol confirmation packet and the path information of the protection tunnel.

A processing module 706 may parse the route object record of the primary tunnel, search for an end network device on the primary tunnel in the same ring network, set the end network device on the primary tunnel in the same ring as a destination network device of a protection tunnel of the network device, and set the network device as a start network device of the protection tunnel. Wherein, the interface of the end network device on the primary tunnel in the same ring has the same ring number with the egress interface of the network device. The start network device, the destination network device and network devices between the start network device and the destination network device constitute the protection tunnel of the network device.

In an example, before the network device receives the protocol confirmation packet from the next-hop network device, the packet receiving module 701 may receive a protocol request packet from the last-hop network device.

In an example, the read-write module 702 may fill in the route object record contained in the protocol request packet with the ring numbers of the ingress interface and the egress interface of the network device. The ring number of the ingress interface is a number of an interface for receiving the protocol request packet by the network device, and the ring number of the egress interface is a number of an interface for forwarding the protocol request packet by the network device.

In an example, the packet sending module 703 may forward the protocol request packet to the next-hop network device, so that the next-hop network device may fill in the route object record contained in the protocol request packet with ring numbers of the ingress interface and the egress interface of the next-hop network device, and further forward the protocol request packet.

The interface of the network device may belong to one ring network, or belong to multiple ring networks, or does not belong to any ring network. Accordingly, the ring number configuring module 704 may configure multiple ring numbers for the interface when the interface belongs to multiple ring networks, and does not configure ring number for the interface when the interface does not belong to any ring network.

When the egress interface of the network device is configured with multiple ring numbers, the processing module 706 may further parse the route object record of the primary tunnel, search for end network devices on the primary tunnel, wherein an interface of each end network device has the same ring number with the egress interface of the network device, and set each end network device on the primary tunnel as a destination network device of a protection tunnel of the network device.

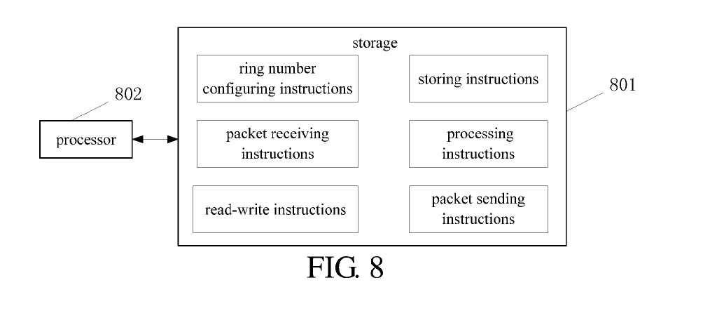

FIG. 8 is a diagram illustrating the structure of a network device according to another example of the present disclosure. The network device may be applied to a ring network, TE FRR is configured on the network device, and an interface of the network device runs RSVP. The network device at least includes a storage 801 and a processor 802 communicated with the storage 801. The storage 801 includes ring number configuring instructions, packet receiving instructions, read-write instructions, storing instructions and processing instructions that can be executed by the processor 802. The storage 801 may be a non-transitory computer readable storage medium, and the ring number configuring instructions, packet receiving instructions, read-write instructions, storing instructions and processing instructions may be machine readable instructions stored in the storage 801. The processor 802 may execute the machine readable instructions stored in the storage 801.

The ring number configuring instructions may configure a ring number for each interface in the ring network. The ring number may identify the ring network, and interfaces of all network devices belonging to the same ring network have the same ring number. The packet receiving instructions may receive a RSVP confirmation packet from a next-hop network device. The read-write instructions may obtain a route object record contained in the RSVP confirmation packet. The route object record contained in the RSVP confirmation packet records ring numbers of ingress interfaces and egress interfaces of all network devices on the primary tunnel. The storing instructions may store the ring numbers, the route object record contained in the RSVP confirmation packet and path information of the protection tunnel. The processing instructions may set an end network device on the primary tunnel in the same ring network as a destination network device of a protection tunnel of the network device, and set the network device as a start network device of the protection tunnel. An interface of the end network device on the primary tunnel in the same ring network has the same ring number with an egress interface of the network device, and the start network device, the destination network device and a network device between the start network device and the destination network device constitute the protection tunnel of the network device.

The network device further includes packet sending instructions, which may forward the RSVP confirmation packet to a last-hop network device. Before the network device receives the RSVP confirmation packet from the next-hop network device, the packet receiving instructions may receive a protocol request packet from the last-hop network device. The read-write instructions may fill in the route object record contained in the protocol request packet with ring numbers of an ingress interface and an egress interface of the network device. The packet sending instructions may forward the protocol request packet to the next-hop network device, so that the next-hop network device fills in the route object record contained in the protocol request packet with ring numbers of an ingress interface and an egress interface of the next-hop network device and forwards the protocol request packet.

The ring number of the ingress interface of the network device is a number of an interface for receiving the protocol request packet by the network device. The ring number of the egress interface of the network device is a number of an interface for forwarding the protocol request packet by the network device.

The ring number configuring instructions may configure multiple ring numbers for an interface of the network device when the interface belongs to multiple ring networks, and configure no ring number for the interface of the network device when the interface does not belong to any ring network.

When the egress interface of the network device is configured with multiple ring numbers, the processing instructions may further parse the route object record of the primary tunnel, search for end network devices on the primary tunnel in the same ring network, wherein ring numbers of interfaces of the end network devices are respectively the same as the multiple ring numbers of the egress interface of the network device, and set each end network device on the primary tunnel as a destination network device of a protection tunnel of the network device, so as to establish multiple protection tunnels.

By the solution of the present disclosure, the working CRLSP may be protected when multiple nodes are failed, which is advantageous to the development of communication technologies.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A method for establishing a protection tunnel, applied to a network device in a ring network and comprising:
configuring, by the network device, a unique ring number for each interface in the same ring network, and storing the ring number;
receiving, by the network device, a Resource Reservation Protocol (RSVP) confirmation packet from a next-hop network device, storing a route object record contained in the RSVP confirmation packet, and the route object record contained in the RSVP confirmation packet recording ring numbers of ingress interfaces and egress interfaces of network devices on a primary tunnel; and
parsing, by the network device, the route object record of the primary tunnel, setting an end network device on the primary tunnel in the same ring network as a destination network device of a protection tunnel of the network device, setting the network device as a start network device of the protection tunnel, and storing path information of the protection tunnel; an interface of the end network device on the primary tunnel in the same ring network having the same ring number with an egress interface of the network device.

2. The method of claim 1, before the network device receives the RSVP confirmation packet from the next-hop network device, further comprising:
receiving, by the network device, a protocol request packet from a last-hop network device, filling in the route object record contained in the protocol request packet with ring numbers of an ingress interface and an egress interface of the network device, forwarding the protocol request packet to the next-hop network device, so that the next-hop network device fills in the route object record contained in the protocol request packet with ring numbers of an ingress interface and an egress interface of the next-hop network device and forwards the protocol request packet.

3. The method of claim 1, wherein the ring number of the ingress interface of the network device is a number of an interface for receiving the protocol request packet by the network device; and
the ring number of the egress interface of the network device is a number of an interface for forwarding the protocol request packet by the network device.

4. The method of claim 1, further comprising:
configuring multiple ring numbers for an interface of the network device when the interface belongs to multiple ring networks; and
configuring no ring number for the interface of the network device when the interface does not belong to any ring network.

5. The method of claim 1, when the egress interface of the network device is configured with multiple ring numbers, further comprising:
parsing, by the network device, the route object record of the primary tunnel, searching for end network devices on the primary tunnel in the same ring network, wherein ring numbers of interfaces of the end network devices are respectively the same as the multiple ring numbers of the egress interface of the network device, and setting each end network device on the primary tunnel as a destination network device of a protection tunnel of the network device, so as to establish multiple protection tunnels.

6. The method of claim 4, when the egress interface of the network device is configured with multiple ring numbers, further comprising:
parsing, by the network device, the route object record of the primary tunnel, searching for end network devices on the primary tunnel in the same ring network, wherein ring numbers of interfaces of the end network devices are respectively the same as the multiple ring numbers of the egress interface of the network device, and setting each end network device on the primary tunnel as a destination network device of a protection tunnel of the network device, so as to establish multiple protection tunnels.

7. The method of claim 1, wherein the ring number is configured to identify the ring network, interfaces of all network devices belonging to the same ring network have the same ring number.

8. A network device, for use in a ring network and comprising:
a ring number configuring module, to configure a unique ring number for each interface in the same ring network;
a packet receiving module, to receive a Resource Reservation Protocol (RSVP) confirmation packet from a next-hop network device;
a read-write module, to obtain a route object record contained in the RSVP confirmation packet, and the route object record contained in the RSVP confirmation packet recording ring numbers of ingress interfaces and egress interfaces of all network devices on the primary tunnel;
a storing module, to store the ring numbers, the route object record contained in the RSVP confirmation packet and path information of the protection tunnel;
a processing module, to set an end network device on the primary tunnel in the same ring network as a destination network device of a protection tunnel of the network device, and set the network device as a start network device of the protection tunnel; an interface of the end network device on the primary tunnel in the same ring network having the same ring number with an egress interface of the network device.

9. The network device of claim 8, further comprising a packet sending module, to forward the RSVP confirmation packet to a last-hop network device, wherein, before the network device receives the RSVP confirmation packet from the next-hop network device,
the packet receiving module is to receive a protocol request packet from the last-hop network device;
the read-write module is to fill in the route object record contained in the protocol request packet with ring numbers of an ingress interface and an egress interface of the network device;
the packet sending module is to forward the protocol request packet to the next-hop network device, so that the next-hop network device fills in the route object record contained in the protocol request packet with ring numbers of an ingress interface and an egress interface of the next-hop network device and forwards the protocol request packet.

10. The network device of claim 8, wherein
the ring number of the ingress interface of the network device is a number of an interface for receiving the protocol request packet by the network device; and
the ring number of the egress interface of the network device is a number of an interface for forwarding the protocol request packet by the network device.

11. The network device of claim 8, wherein the ring number configuring module is to configure multiple ring numbers for an interface of the network device when the interface belongs to multiple ring networks, and configure no ring number for the interface of the network device when the interface does not belong to any ring network.

12. The network device of claim 8, wherein, when the egress interface of the network device is configured with multiple ring numbers, the processing module is further to parse the route object record of the primary tunnel, search for end network devices on the primary tunnel in the same ring network, wherein ring numbers of interfaces of the end network devices are respectively the same as the multiple ring numbers of the egress interface of the network device, and set each end network device on the primary tunnel as a destination network device of a protection tunnel of the network device, so as to establish multiple protection tunnels.

13. The network device of claim 11, wherein, when the egress interface of the network device is configured with multiple ring numbers, the processing module is further to parse the route object record of the primary tunnel, search for end network devices on the primary tunnel in the same ring network, wherein ring numbers of interfaces of the end network devices are respectively the same as the multiple ring numbers of the egress interface of the network device, and set each end network device on the primary tunnel as a destination network device of a protection tunnel of the network device, so as to establish multiple protection tunnels.

14. The network device of claim 8, wherein the ring number is configured to identify the ring network, interfaces of all network devices belonging to the same ring network have the same ring number.
